(19) United States
(12) Patent Application Publication
(10) Pub. No.: US 2026/0086511 A1
(43) Pub. Date: Mar. 26, 2026

(54) FAST ATTENTION MECHANISMS FOR PHYSICAL SYSTEMS

(71) Applicant: DeepMind Technologies Limited, London (GB)

(72) Inventors: Oliver Thorsten Unke, Berlin (DE); Jan Thorben Frank, Berlin (DE)

(21) Appl. No.: 18/897,283

(22) Filed: Sep. 26, 2024

(51) Int. Cl. G05B 13/02

(52) U.S. Cl. CPC G05B 13/027; G05B 13/026

(57) ABSTRACT

Methods, systems, and apparatus, including computer programs encoded on a computer storage medium, for generating a prediction characterizing a physical system. In one aspect, a method comprises: generating, for each of the plurality of objects in the physical system, a feature embedding for the object; generating, for each of the plurality of objects, a spatial encoding for the object representing the spatial location of the object, wherein: the spatial encoding for each object comprises a representation of a complex number characterizing a spatial relationship between the position vector for the object and a shared reference vector; and generating an embedding of the physical system by combining, for each of the plurality of objects, the feature embedding for the object with the spatial encoding for the object; and processing the embedding of the physical system to generate a prediction characterizing the physical system.

### BACKGROUND

This specification relates to a spatial encoding system that enables a machine learning model to implement a fast attention mechanism for generating predictions about a physical system.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can generate predictions for physical systems using spatial encodings for objects within the physical system that characterize geometric relationships between the objects. In particular, the system can use the spatial encodings to generate predictions for the physical system that follow certain symmetry properties for the physical system.

Throughout this specification, an “embedding” of an entity (e.g., object) can refer to a representation of the entity as an ordered collection of numerical values, e.g., a vector, matrix, or other tensor of numerical values.

Particular embodiments of the subject matter described in this specification can be implemented so as to realize one or more of the following advantages.

Many properties of physical systems depend on geometric relationships between objects within the physical systems. For example, properties of a chemical system (e.g., energies of the system, inter-atomic forces of the system, and so on) depend on the arrangement of atoms in the chemical system.

Aspects of physical systems often follow certain symmetry properties. As one example, one or more properties for a physical system can be “invariant” (e.g., exhibit “invariance”) with respect to one or more changes to coordinates of the physical system. When a property is invariant with respect to a particular change of coordinates for the physical system, values of the property are unaffected by the particular change of coordinates for the physical system. For example, energies of a chemical system can be invariant with respect to global rotations and translations of the coordinates of the atoms of the chemical system. (e.g., the energies of the chemical system can remain the same when the chemical system is moved or rotated as a whole).

As another example, one or more properties for a physical system can be “equivariant” (e.g., exhibit “equivariance”) with respect to one or more changes to coordinates of the physical system. When a property is equivariant with respect to a particular change of coordinates for the physical system, values of the property are affected by the particular change of coordinates in the same manner that the coordinates for the physical system are affected by the particular change of coordinates. For example, the inter-atomic forces within chemical systems can be equivariant with respect to global rotations and translations of the coordinates of the atoms of the chemical system (e.g., when the chemical system is moved or rotated as a whole, inter-atomic force vectors of the chemical system can be moved and rotated in the same manner as the chemical system as a whole).

Although conventional methods for encoding object positions for machine learning models can specify object positions for the purpose of generating individual predictions, conventional methods for encoding spatial positions often do not encourage or enforce generating invariant or equivariant predictions based on the encoded positions. The described systems can encode the spatial positions of objects by encoding a geometric relationship between each object with shared reference vectors for the objects. Generating the spatial encodings for objects using the shared reference vectors enables the described systems to more efficiently encode geometric relations between the objects and to more efficiently predict properties of physical systems.

As an example, in some implementations, the described systems can generate multiple spatial encodings for each object in a physical system using a plurality of shared reference vectors. The described systems can utilize the multiple spatial encodings to generate invariant and equivariant predictions and predicted features for the physical systems. For conventional encoding methods, training a machine learning model to generate invariant or equivariant predictions and predicted features often requires training the machine learning model using large numbers of training examples that indirectly demonstrate the desired symmetry properties of the physical system. By directly generating invariant and equivariant predictions (e.g., rather than by indirectly learning to generate invariant and equivariant predictions), the described systems can be trained to generate predictions for physical systems using fewer computational resources (e.g., computational run time, memory usage, power consumption, etc.) than conventional systems.

As another example, in some implementations, the described systems can use the spatial encodings for the objects to efficiently compute global self-attention operations with attention weights for the objects that depend on geometric relationships between the objects. In particular, the described systems can determine attention weights for the objects using a combined key-value matrix for the plurality of objects that incurs a computational cost (e.g., computational run time, memory usage, etc.) that scales linearly with respect to the number of objects in the physical system. Conventional methods for performing attention operations (e.g., computing pair-wise attention weights for each pair of the objects) can incur a computational cost that scales quadratically with respect to the number of objects in the physical system. Conventional methods for using attention mechanisms to generate predictions for physical systems can therefore be impractical for generating predictions for physical systems with large numbers of objects. In some cases, the computational cost of conventional methods can be reduced by enforcing a distance cutoff that limits the number of pair-wise attention weights that are computed. However, by omitting long-range interactions within the physical systems, these distance cutoffs can result in less accurate predictions. Therefore, by enabling global attention operations (e.g., attention operations determined based on the positions of all objects within the physical system) with a computational cost that scales linearly with the number of objects in the physical system, the described systems can generate more accurate predictions for large-scale physical systems more efficiently than conventional methods.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example prediction system.

FIG. 2 is a block diagram of an example embedding neural network.

FIG. 3 is a block diagram of an example prediction neural network.

FIG. 4 is a flow diagram of an example process for generating predictions for a physical system using a prediction system.

FIG. 5A is a flow diagram of an example process for processing object embeddings from an embedding neural network using a prediction neural network.

FIG. 5B is a flow diagram of an example process for using an attention neural network layer to generate attention weights that depend on spatial encodings for objects in a physical system.

FIG. 5C is a flow diagram of an example process for generating updated embeddings for objects in a physical system using spatial encodings for the objects for a plurality of shared reference vectors.

FIG. 6 illustrates example equivariant vector predictions that can be generated by a prediction system.

FIG. 7 illustrates example experimental results demonstrating improved computational costs of the described methods in comparison with conventional methods.

Like reference numbers and designations in the various drawings indicate like elements.

### DETAILED DESCRIPTION

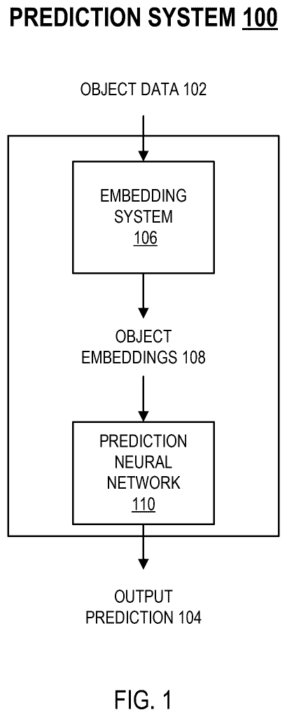

FIG. 1 shows an example prediction system 100. The prediction system 100 is an example of a system implemented as computer programs on one or more computers in one or more locations in which the systems, components, and techniques described below are implemented.

The prediction system 100 can process object data 102 characterizing properties of a plurality of objects within a physical system to generate an output prediction 104 regarding the physical system.

The physical system can be any of a variety of systems that can include any of a variety of physical objects. For example, the physical system can be an environment (e.g., a driving environment) that includes a plurality of agents (e.g., vehicles, pedestrians, etc.) and the object data 102 can characterize the plurality of agents in the environment. As another example, the physical system can include one or more physical surfaces and the object data 102 can characterize a plurality of points defining the physical surfaces. As another example, the physical system can be a chemical system and the object data 102 can characterize a plurality of, e.g., ions, atoms, groups of atoms, molecules, and so on within the chemical system.

For each object within the physical system, the object data 102 can specify a position (e.g., a 3D spatial position) of the object within the physical system. The object data 102 can also characterize one or more physical properties of each object. For example, when the physical system is an environment that includes a plurality of agents, the object data 102 can include data characterizing, e.g., a classification, an observed trajectory, and so on for each of the plurality of agents. As another example, when the physical system is a chemical system, the object data 102 can include data characterizing, e.g., a chemical composition, a charge, a hybridization, a mass, and so on for each object in the chemical system.

The output prediction 104 can be any appropriate prediction for the physical system. For example, when the physical system is an environment that includes a plurality of agents, the output prediction 104 can include, e.g., predicted classifications, predicted trajectories, and so on for one or more of the agents. As another example, when the physical system includes one or more physical surfaces, the output prediction 104 can include, e.g., predicted classifications, predicted trajectories, and so on for one or more of the physical surfaces. As another example, when the physical system is a chemical system, the output prediction 104 can include, e.g., predicted energies, predicted trajectories, predicted inter-atomic forces, predicted material properties, and so on for one or more of the objects in the chemical system.

The output prediction 104 generated by the prediction system 100 can be used to perform any of a variety of downstream tasks. For example, when the physical system is an environment that includes a plurality of agents, the output prediction 104 can be used to perform a navigation task in the environment (e.g., to control a vehicle in the environment). In general, the agent can be a mechanical agent, e.g., a robot or vehicle, controlled to perform actions in the real world environment, in response to the observations, to perform a task, e.g. to manipulate an object or to navigate in the environment. Thus the agent can be, e.g., a real-world or simulated robot; as some other examples the agent can be a control system to control one or more machines or items of equipment in an industrial facility, e.g., to control an industrial process, such as a manufacturing process, electricity generation, recycling process, and so on.

As another example, when the physical system includes one or more physical surfaces, the output prediction 104 can be used to generate a simulation or rendering of the physical system (e.g., for presentation to a user).

As another example, when the physical system is a chemical system and when the output predictions 104 characterize predicted properties of molecules within the chemical system, the output predictions 104 can be used to screen a set of candidate molecules for physical synthesis.

The prediction system 100 can receive data characterizing one or more test molecules. The test molecules can be any of a variety of molecules (e.g., organic molecules, inorganic molecules, proteins, ligands, crystals, polymers, nucleic acids, etc.). For each of the test molecules, the prediction system 100 can generate object data 102 for the test molecule that characterizes a chemical system that includes the test molecule.

The prediction system 100 can process the object data 102 for the test molecule to generate one or more predicted properties of the test molecule. The predicted properties of the test molecule can include any of a variety of properties. As an example, the predicted properties of the test molecule can include one or more material properties of the test molecule (e.g., bulk modulus, elasticity, strain, etc.). As another example, the predicted properties of the test molecule can include one or more physio-chemical properties of the test molecule (e.g., a solubility of the test molecule, a permeability of the test molecule, a chemical stability of the test molecule, a lipophilicity of the test molecule, a strength of plasma protein binding of the test molecule, a volume of distribution of the test molecule, properties characterizing enzymatic pathways responsible for metabolizing the test molecule, metabolic rate properties for the test molecule, properties characterizing metabolites generated by metabolism of the test molecule, etc.). As another example the predicted properties of the test molecule can include a binding affinity of the test molecule (e.g., a binding affinity of the test molecule with a target molecule, such as a target ligand, a target protein, a target nucleic acid, and so on).

The prediction system 100 can determine the set of candidate molecules for physical synthesis by screening the one or more test molecules based on the predicted properties for the test molecules. In particular, for each test molecule, the system 100 can evaluate one or more screening criteria for the test molecule based on the predicted properties of the test molecule and can generate output data characterizing a decision to physically synthesize the test molecule based on the evaluated screening criteria for the test molecule. In particular, the screening criteria can specify desired properties for the test molecules, e.g., desired binding affinities, material properties, physio-chemical properties, and so on. For example, the screening criteria can specify that a test molecule should bind (e.g., to an enzyme or receptor) with sufficient affinity for an effect on a function of a target molecule (e.g., a protein or nucleic acid, such as DNA or RNA), e.g., sufficient affinity for a biological effect. As an example, the test molecules can be screened according to whether they are agonists or antagonists of a receptor or enzyme. The evaluation of the interaction of a test molecule with a target molecule may be performed using a computer-aided approach in which graphical models of the test molecule and target molecule structure are displayed for user-manipulation, and/or the evaluation may be performed partially or completely automatically, for example using standard molecular (e.g. protein-ligand) docking or molecular dynamics software.

The output data characterizing the decision to physically synthesize the test molecule data can include data characterizing a request to physically synthesize the test molecule. The prediction system 100 can determine the set of candidate molecules for physical synthesis to be the test molecules that satisfy the screening criteria. After the prediction system 100 determines the set of candidate molecules for physical synthesis, the system 100 can output a request to physically synthesize the candidate molecules and the candidate molecules can be physically synthesized in response to the request. In some implementations, the biological activity of the candidate molecules may then be tested in vitro and/or in vivo. For example the candidate molecules may be tested for ADME (absorption, distribution, metabolism, excretion) and/or toxicological properties, to screen out unsuitable ligands. The testing may include, e.g., bringing the candidate small molecule, polypeptide or polynucleotide ligand into contact with a target molecule (e.g. protein) and measuring a change in expression or activity of the target molecule.

Components of the prediction system 100 are described next (and throughout this specification).

The prediction system 100 can include an embedding system 106. As part of generating the output prediction 104 for the physical system, the prediction system 100 can process the object data 102 using the embedding system 106 to generate object embeddings 108 for the physical system.

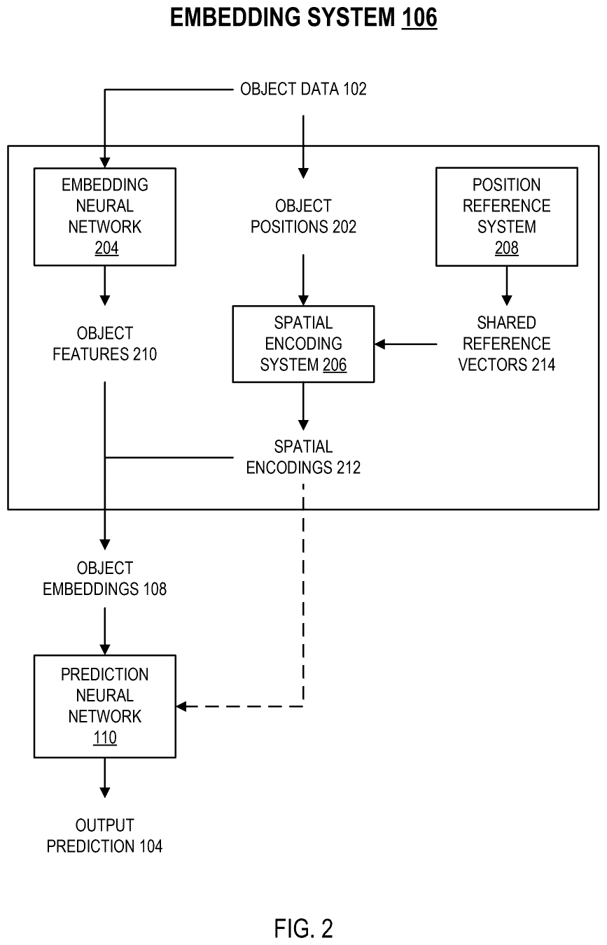

The embedding system 106 can process the object data 102 to generate a respective object embedding 108 for each object of the physical system. For each object, the embedding system 106 can generate one or more spatial encodings for the object that characterize the position of the object within the physical system. The embedding system 106 can generate the object embeddings 108 using the spatial encodings for the objects within the system. The embedding system 106 is described in more detail below with reference to FIG. 2.

The prediction system 100 can include a prediction neural network 110 configured to process the object embeddings 108 to generate the output prediction 104. The prediction neural network 110 can be trained to generate output predictions using any appropriate machine learning technique. In particular, the prediction neural network 110 can be trained using a set of training data that includes a plurality of training examples. Each training example can include (i) example object data for the training example and (ii) a target prediction for the training example. For example, when the physical system is a chemical system, the example object data for the training example can characterize an example chemical system for the training example and the target prediction for the training example can characterize one or more target properties of the chemical system. The target predictions for the training examples can be determined by any appropriate method, e.g., by experimental testing, using molecular dynamics simulations, and so on. In particular, the target predictions for the training examples can be determined using electronic structure calculations, such as density functional theory calculations, coupled cluster calculations, variational Monte Carlo calculations, and so on.

The prediction neural network 110 can be trained to optimize a loss function (e.g., a regression loss, a cross-entropy loss, etc.) that measures an error between (i) the target predictions for the training examples and (ii) output predictions generated by the prediction neural network processing object embeddings generated based on the example object data for the training example. In some implementations, the embedding system 106 can be jointly trained with the prediction neural network 110 to optimize the loss function (e.g., by back-propagating gradients of the loss function to optimize parameters of the embedding system 106).

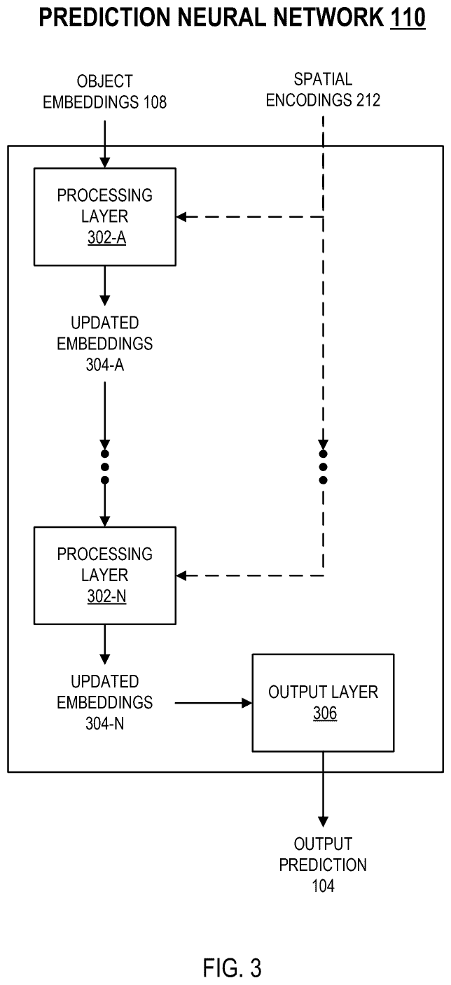

The prediction neural network 110 is described in more detail below with reference to FIG. 3.

FIG. 2 shows an example embedding system 106. The embedding system 106 is an example of a system implemented as computer programs on one or more computers in one or more locations in which the systems, components, and techniques described below are implemented.

The embedding system 106 can process object data 102 for a physical system to generate object embeddings 108 for the physical system. As described above, the object data 102 can specify (i) object positions 202 within the physical system for each of a plurality of objects in the physical system and (ii) one or more physical properties of each of the plurality of objects. The object embeddings 108 for the physical system can include a respective embedding for each object in the physical system that includes object features that characterize the physical properties of the object and one or more spatial encodings for the object generated by the embedding system 106.

The embedding system 106 can include an embedding neural network 204, a spatial encoding system 206, and a position reference system 208, which are each described next (and throughout this specification).

The embedding neural network 204 can process the object data 102 for the physical system to generate object features 210 characterizing the physical properties of the objects. The object features 210 can include, for each object of the physical system, one or more numerical values (e.g., feature vectors) characterizing the physical properties of the object.

The embedding neural network 204 can have any appropriate architecture for processing the object data 102 to generate the object features 210. For example, the embedding neural network 204 can include any of a variety of processing layers (e.g., multi-layer perceptron layers, convolutional layers, recurrent layers, attention layers, etc.) in any appropriate combination for generating the object features 210.

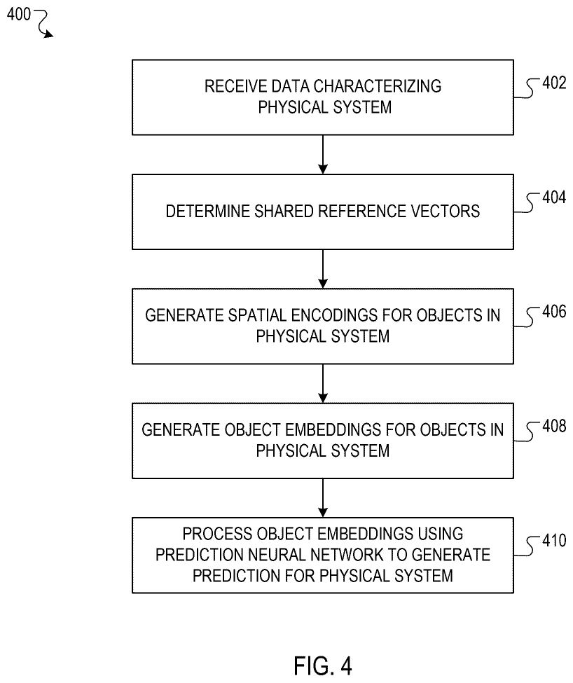

The spatial encoding system 206 can process the object positions 202 to determine one or more spatial encodings 214 for each object within the physical system. As described in more detail below with reference to FIG. 4, the spatial encodings 214 can characterize and represent geometric relationships between the objects of the physical system.

The spatial encoding system 206 can generate each of the spatial encodings 214 for a particular object with reference to a respective shared reference vector 216 for the spatial encoding for the object. In particular, each of the spatial encodings 214 can characterize a relationship between the shared reference vector 216 for the spatial encoding and the position vector for the object of the spatial encoding.

The spatial encoding system 206 can use the same shared reference vectors 216 to generate the spatial encodings for each of the objects of the physical system. For example, for each of the shared reference vectors 216, the spatial encoding system 206 can generate a respective spatial encoding 214 for each of the objects of the physical system using the shared reference vector 216.

The position reference system 208 can select the one or more shared reference vectors 214 the network 106 uses to generate the spatial encodings 212 for the objects.

The embedding system 106 can generate the object embeddings 108 by combining, for each object in the physical system, the object features 210 generated for the object and the spatial encodings 212 determined for the object.

An example process of generating the object embeddings 108 for the physical system using the embedding system 106 is described in more detail below with reference to FIG. 4.

The object embeddings 108 for the physical system can be processed by a prediction neural network 110 to generate an output prediction 104 for the physical system. The neural network 110 can include a sequence of multiple processing layers and can generate the output prediction 104 by, for each of the sequence of processing layers, processing a respective input for the processing layer to generate a respective output for the processing layer. In some implementations each of the sequence of processing layers can receive and process the spatial encodings 212 for the objects as part of generating the respective output for the processing layer.

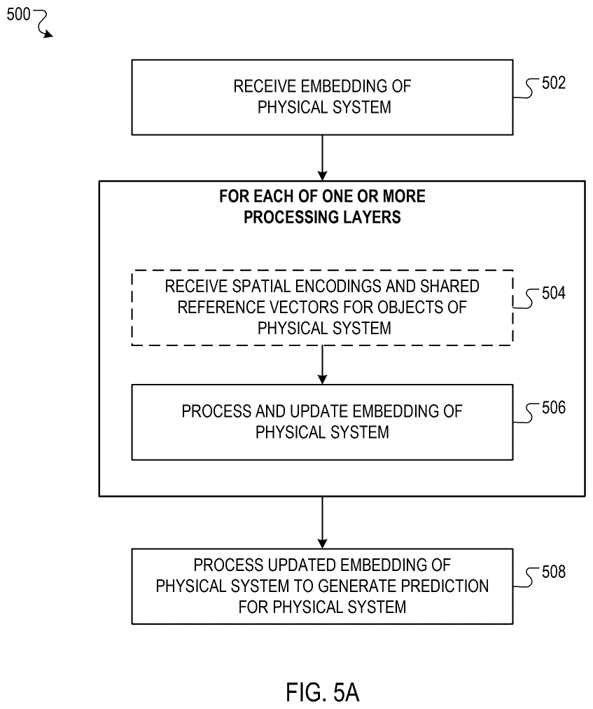

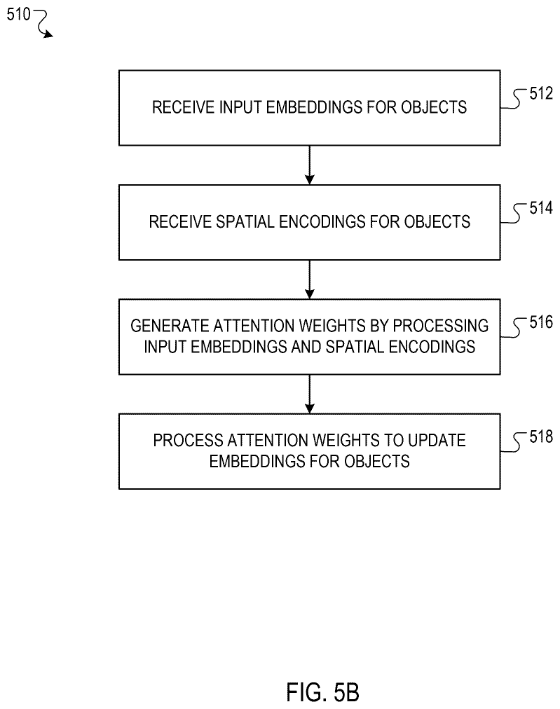

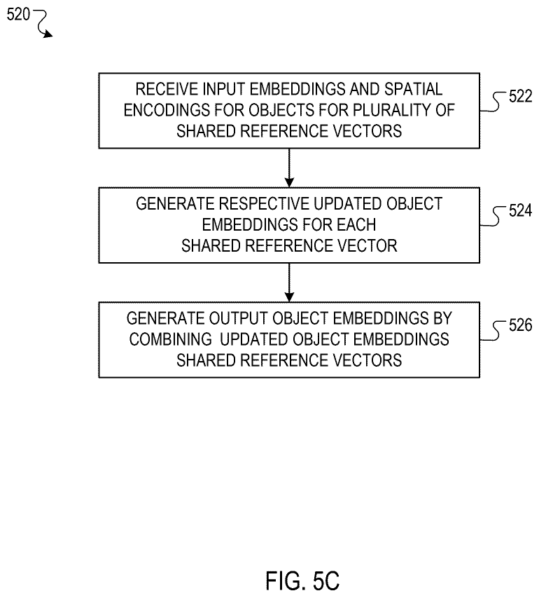

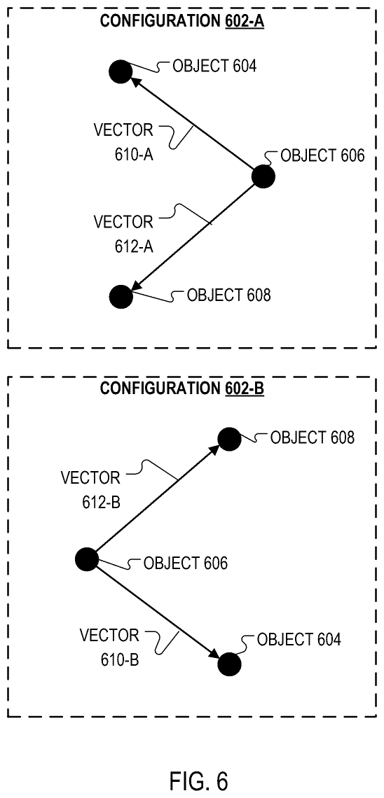

As described in more detail below with reference to FIG. 4 and FIG. 5A, the embedding system 106 can select the shared reference vectors 214 and can generate the spatial encodings 212 for the objects to encourage or ensure that the prediction neural network 110 generates the output prediction 104 in accordance with certain symmetry properties for the physical system (e.g., rotational invariance, equivariance, and so on). Example equivariant predictions that can be generated by the prediction neural network 110 using the spatial encodings 212 are described in more detail below with reference to FIG. 6.

FIG. 3 shows an example prediction neural network 110. The prediction neural network 110 is an example of a system implemented as computer programs on one or more computers in one or more locations in which the systems, components, and techniques described below are implemented.

As described above, the prediction neural network 110 can process object embeddings 108 (e.g., object embeddings 108 generated using an embedding neural network, such as the embedding system 106 of FIG. 2) for a plurality of objects of a physical system to generate an output prediction 104 for the physical system. In some implementations, as part of generating the output prediction 104, the prediction neural network 110 can process spatial encodings 212 for the objects.

The prediction neural network 110 can include a sequence of one or more processing layers 302-A through 302-N. Each of the processing layers 302-A through 302-N can be configured to process a layer input for the layer to generate respective updated object embeddings 304-A through 304-N for the objects of the physical system. In some implementations, each of the processing layers 302-A through 302-N can process the spatial encodings 212 for the objects of the physical system as part of generating the updated object embeddings 304-A through 304-N for the objects.

Each of the processing layers 302-A through 302-N can have any appropriate architecture for generating the updated object embeddings 304-A through 304-N for the objects of the physical system. For example, the processing layers 302-A through 302-N can include any of a variety of processing layers (e.g., multi-layer perceptron layers, convolutional layers, recurrent layers, attention layers, etc.) in any appropriate combination for generating the updated object embeddings 304-A through 304-N for the objects of the physical system.

The prediction neural network 110 can generate the output prediction 104 by processing the final updated object embeddings (e.g., the updated embeddings 304-N generated by the final processing layer 302-N) using an output layer 306. The output layer 306 can have any appropriate architecture for generating the output prediction 104. For example, the output layer 306 can include any of a variety of processing layers (e.g., multi-layer perceptron layers, convolutional layers, recurrent layers, attention layers, etc.) in any appropriate combination for generating the output prediction 104 for the physical system.

An example process of generating the output prediction 104 using the prediction neural network 110 is described in more detail below with reference to FIG. 5A.

FIG. 4 is a flow diagram of an example process for generating predictions for a physical system using a prediction system. For convenience, the process 400 will be described as being performed by a system of one or more computers located in one or more locations. For example, a prediction system, e.g., the prediction system 100 of FIG. 1, appropriately programmed in accordance with this specification, can perform the process 400.

The system can receive data characterizing a physical system (step 402). In particular, the data characterizing the physical system can characterize properties for a plurality of objects within the physical system. For example, for each object in the physical system, the data characterizing the physical system can specify, e.g., a position vector representing a spatial location of the object in the physical system, one or more physical properties of the object, and so on.

The system can receive data characterizing any of a variety of physical systems. For example, the system can receive data characterizing agents (e.g., vehicles, pedestrians, etc.) navigating an environment. As another example, the system can receive data characterizing natural objects interacting in a physical system. As a particular example, the system can receive data characterizing, e.g., atoms, groups of atoms, molecules, and so on, interacting in a chemical system.

The position vectors for the objects can have any appropriate dimensionality for the physical system. For example, the position vectors for the objects can specify respective n-dimensional (e.g., 2-dimensional, 3-dimensional, 4-dimensional, 100-dimensional, etc.) spatial locations for the objects in the physical system. That is, a spatial location for each object (e.g., a point in 3D space) can be represented by a respective n-dimensional vector.

The system can determine one or more shared reference vectors for the objects of the physical system (step 404). Each shared reference vector can be a unitary vector (e.g., a vector of unit magnitude) having the same dimensionality as the position vectors for the plurality of objects within the physical system.

The system can select multiple shared reference vectors in accordance with certain symmetries of the physical system. As an example, the physical system can include a material (e.g., crystal, such as a salt, a metal, a semi-conductor, a polymer, etc.) characterized by a unit cell and the system can select the shared reference vectors as defined by the unit cell (e.g., lattice vectors of the unit cell). As another example, the system can select multiple shared reference vectors by randomly sampling the shared reference vectors from a distribution of shared reference vectors (e.g., a distribution of unitary n-dimensional vectors). As another example, the system can select multiple shared reference vectors in accordance with a numerical integration procedure with respect to the shared reference vectors. As a particular example, when the shared reference vectors are 3-dimensional unitary vectors, the multiple shared reference vectors can be selected in accordance with a Lebedev quadrature for a sphere.

As described in more detail below with reference to FIG. 5C, when the system selects multiple shared reference vectors, the system can use the multiple shared reference vectors to encourage or enforce desired symmetry properties of the predictions for the physical system.

For each shared reference vector and for each object of the physical system, the system can generate a spatial encoding for the object with respect to the shared reference vector (step 406). In particular, a spatial encoding for an object with respect to a shared reference vector can include a representation of a complex number characterizing a spatial relationship between the position vector for the object and the shared reference vector.

As an example, the spatial encoding for an n-th object in the physical system with respect to a shared reference vector, \vec{u}, can include a representation of the complex number defined by the dot (scalar) product \vec{u}·\hat{r}ₙ, e.g.:

$${e}^{i ω \vec{u} \cdot {\vec{r}}_{n}}$$

Where ω is a parameter for the spatial encoding and \vec{r}ₙ is the position of the n-th object in the physical system.

The spatial encodings for a pair of objects can encode information characterizing geometric relationships between the pair of objects (e.g., a distance between the pair of objects, a displacement between the pair of objects, etc.) within the physical system. In particular, inner products between spatial encodings for a pair of objects can characterize geometric relationships between the pair of objects. For example, the inner product <⋅,⋅> defined as:

$$< A , B >= {A}^{T} \overline{B}$$

Can characterize a geometric relationship between an m-th object in the physical system and an n-th object in the physical system following:

$$< {X}_{m} {e}^{i ω \vec{u} \cdot {\vec{r}}_{m}} , {Y}_{n} {e}^{i ω \vec{u} \cdot {\vec{r}}_{n}} > = < {X}_{m} , {Y}_{n} > {e}^{i ω \vec{u} \cdot ( {\vec{r}}_{m} - {\vec{r}}_{n} )} = < {X}_{m} , {Y}_{n} > {e}^{i ω \vec{u} \cdot {\vec{r}}_{mn}}$$

Where Xₘ is a matrix of features for the m-th object in the physical system, Yₙ is a matrix of features for the n-th object in the physical system, and \vec{r}ₘₙ=\vec{r}ₘ−\vec{r}ₙ is the displacement between the positions of the m-th and n-th objects in the physical system.

The spatial encodings can represent the complex numbers encoding the positions of the objects of the physical system by any of a variety of methods. As an example, the representations can be complex-valued scalars representing the complex numbers. As another example, the representations can be real-valued matrices representing the complex numbers. As a particular example, a spatial encoding can represent the complex number z=a+ib using the real-valued matrix representation Z defined by:

$$Z = [ \begin{matrix}a & - b \\ b & a\end{matrix} ]$$

When the system represents the complex numbers encoding the positions of the objects using real-valued matrices, as above, the system can more efficiently (e.g., with respect to computational costs, such as computational time, memory usage, etc.) process the spatial representations using Graphics Processing Unit (GPU) hardware or Tensor Processing Unit (TPU) hardware. In particular, GPU or TPU hardware can be optimized to efficiently perform matrix operations, e.g., by parallelizing computations for matrix operations, and the system can leverage the optimization of GPU or TPU hardware for matrix operations process to efficiently process the spatial representations by representing the complex numbers encoding the positions of the objects as real-valued matrices. Therefore, in some implementations, the feature embedding for each object can be determined by processing the spatial encodings as real-valued matrix representations of complex numbers using GPU or TPU hardware. As one example, the feature embeddings for each object can be determined efficiently by using GPU or TPU hardware to compute matrix vector products (e.g., in a parallel fashion) between matrices formed from the features for each of the objects and corresponding vectors formed by concatenating the real values (a) or the imaginary values (b) of the complex numbers representing the spatial encodings for the objects.

The system can process the data characterizing the physical system using an embedding neural network to generate, for each of the plurality of objects in the physical system, a feature embedding for the object representing the one or more physical properties of the object (step 408). The embedding neural network can have any appropriate architecture for processing the data characterizing the physical system to generate the feature embeddings for the objects. For example, the embedding neural network can include any of a variety of processing layers (e.g., multi-layer perceptron layers, convolutional layers, recurrent layers, attention layers, etc.) in any appropriate combination for generating the feature embeddings.

For each of the plurality of objects, the system can combine the feature embedding for the object with each spatial encoding for the object. For example, the system can generate a combined object embedding for each object that includes a multiplication of the feature embedding of the object with each spatial encoding for the object.

The system can use the object embeddings for each of the objects within the physical system to generate an embedding of the physical system. For example, the system can generate a graph representing the physical system that includes, for each object of the physical system, a graph node representing the object. Each of the graph nodes can be associated with the object embedding for the corresponding object represented by the graph node. As another example, the system can generate a sequence of embeddings representing the physical system that includes, for each object of the physical system, an object embedding representing the object.

The system can process the embeddings for the objects using a prediction neural network to generate a prediction for the physical system (step 410). In particular, the prediction neural network can process the embedding of the physical system as a network input to generate the prediction for the physical system.

The prediction neural network can have any appropriate architecture for processing the embedding of the physical system to generate the prediction for the physical system. For example, the prediction neural network can include any of a variety of processing layers (e.g., multi-layer perceptron layers, convolutional layers, recurrent layers, attention layers, etc.) in any appropriate combination for generating the prediction for the physical system.

In some implementations, the prediction neural network can receive and process the spatial encodings for the objects of the physical systems as part of generating the prediction for the physical system. An example process for generating the prediction for the physical system using the prediction neural network is described in more detail below with reference to FIG. 5A.

FIG. 5A is a flow diagram of an example process for processing object embeddings from an embedding neural network using a prediction neural network. For convenience, the process 500 will be described as being performed by a system of one or more computers located in one or more locations. For example, a prediction system, e.g., the prediction system 100 of FIG. 1, appropriately programmed in accordance with this specification, can perform the process 500.

The system can receive an embedding of a physical system as a network input to the prediction neural network (step 502). The embedding of the physical system can include, for each of a plurality of objects in the physical system, a respective embedding for the object that includes one or more features characterizing properties of the object.

The embedding of the physical system can be any appropriate embedding for processing by the prediction neural network. For example, when the prediction neural network includes a graph neural network, the embedding of the physical system can include a graph representing the physical system that includes, for each object of the physical system, a graph node representing the object. The graph representing the physical system can include one or more graph edges between the graph nodes, where each graph edge connects a respective pair of graph nodes and can represent a relationship or interaction between the objects represented by the pair of graph nodes.

As another example, when the prediction neural network includes an attention neural network, the embedding of the physical system can include a sequence of embeddings representing the physical system that includes, for each object of the physical system, an object embedding representing the object.

As described above with reference to FIG. 4, the object embedding for each object can be derived from one or more spatial encodings for the object generated using respective shared reference vectors for the objects. In some implementations, the system can receive the spatial encodings for the objects, the shared reference vectors, or both as inputs of the prediction neural network.

As described above with reference to FIG. 3, the prediction neural network can include one or more processing layers. The system can process the embedding of the physical system to generate an updated embedding of the physical system using the one or more processing layers, e.g., by performing steps 504 and 506 for each processing layer.

When the system receives the spatial encodings for the objects as inputs of the prediction neural network, each processing layer can optionally receive the spatial encodings as a layer input (step 504). Similarly, when the system receives the shared reference vectors for the objects as inputs of the prediction neural network, each processing layer can optionally receive the shared reference vectors as a layer input.

The system can process a current embedding of the physical system using the processing layer to update the embedding of the physical system (step 506). Each processing layer can have any appropriate neural architecture for processing and updating the embedding of the physical system. As one example, each processing layer can include a graph neural network configured to process and update (e.g., using one or more message passing layers) a graph representing the physical system (e.g., a graph that includes, for each object of the physical system, a graph node representing the object). As another example, each processing layer can include an attention neural network configured to process and update a sequence of embeddings representing the physical system (e.g., a sequence of embeddings that includes, for each object of the physical system, an object embedding representing the object).

When the processing layer includes an attention neural network, the attention neural network can process and update the object embeddings within the current embedding of the physical system by performing a respective attention operation for each of the objects. For example, the attention neural network can update the object embeddings by performing self-attention operations for each of the object embeddings, e.g., as described by Vaswani et al. in “Attention Is All You Need”.

In some implementations, each processing layer can include multiple neural networks (e.g., a graph neural network and an attention neural network) configured to process and update the object embeddings. Each processing layer can determine a respective updated embedding generated by each neural network within the processing layer and can generate updated object embeddings for the layer by combining (e.g., by summing, averaging, etc.) the updated embeddings generated by the neural networks within the processing layer.

In general, as part of performing a self-attention operation, the attention neural network can determine a respective key feature vector, query feature vector, and value feature vector for each of the objects based on the current feature embeddings for the objects. The attention neural network can generate an updated embedding for an n-th object of the physical system as a linear combination specified by:

$${\sum }_{m} A ( {q}_{n} , {k}_{m} ) {v}_{m}$$

Where qₙ is the query feature vector for the n-th object, kₘ is the key feature vector for the m-th object, vₘ is the value feature vector for the m-th object, and A(qₙ, kₘ) is an attention weight of the m-th object for updating the embedding for the n-th object.

For example, as described by Vaswani et al. in “Attention Is All You Need”, A(qₙ, kₘ) can be determined following:

$$A ( {q}_{n} , {k}_{m} ) = \frac{exp \frac{{q}_{n}^{T} {k}_{m}}{\sqrt{{D}_{qk}}}}{{\sum }_{m} exp \frac{{q}_{n}^{T} {k}_{m}}{\sqrt{{D}_{qk}}}}$$

Where D_{qk} is a dimensionality of qₙ and kₘ.

When the attention neural network computes the updated embeddings for the objects of the physical system by computing attention weights between each pair of objects (e.g., as above), the computational cost (e.g., computational run time, memory usage, etc.) of generating the updated embeddings for the objects can scale quadratically with respect to the number of objects in the system. The quadratic cost can make updating the object embeddings by computing attention weights between each pair of objects impractical for physical systems that include large numbers of objects.

In some implementations, to reduce the computational cost of generating the updated embeddings for the objects (e.g., using GPU or TPU hardware), the attention neural network can determine the attention weights as the vector product:

$$A ( {q}_{n} , {k}_{m} ) = {q}_{n}^{T} {k}_{m}$$

When the attention neural network determines the attention weights as the above vector product, the attention neural network can generate the updated embedding for the n-th object of the physical system as the linear combination specified by:

$${\sum }_{m} A ( {q}_{n} , {k}_{m} ) {v}_{m} = {\sum }_{m} ( {q}_{n}^{T} {k}_{m} ) {v}_{m} = {q}_{n}^{T} {\sum }_{m} {k}_{m} {v}_{m}^{T} = {q}_{n}^{T} {M}_{kv}$$

Where

$${M}_{kv} = {\sum }_{m} {k}_{m} {v}_{m}^{T}$$

is a combined key-value matrix for the plurality of objects within the physical system that the attention neural network can use to compute the updated feature embeddings for each of the objects. The combined key-value matrix for the plurality of objects can be determined by any suitable combination (e.g., summation, average, etc.) of vector (outer) products of the key and value feature vectors for the plurality of objects and can have any suitable normalization (e.g., unnormalized, row-normalized, column-normalized, etc.).

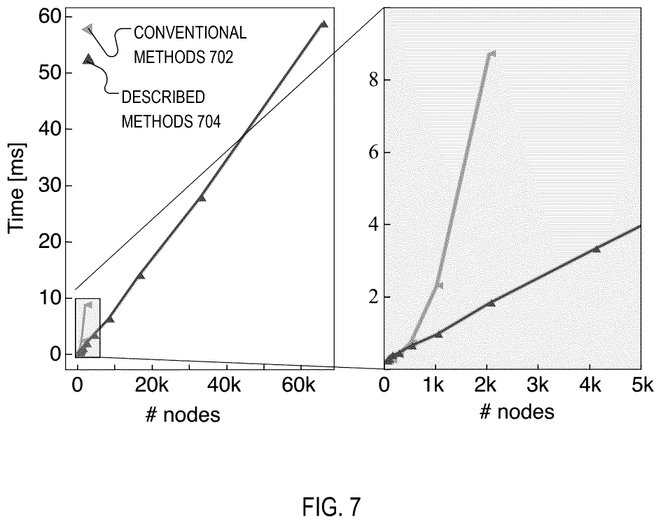

When the attention neural network computes the updated embeddings for the objects of the physical system using a combined key-value matrix for the plurality of objects (e.g., using GPU or TPU hardware), the computational cost (e.g., computational run time, memory usage, etc.) of generating the updated embeddings for the objects can scale linearly with respect to the number of objects in the number of systems. In particular, the computational cost of calculating the combined key-value matrix for the plurality of objects and the computational cost of computing the updated embeddings using the computed combined key-value matrix can both scale linearly with respect to the number of objects in the number of systems. By computing the updated embeddings for the objects of the physical system using the combined key-value matrix, the system can therefore more efficiently update the object embeddings for physical systems with large numbers of objects (e.g., in comparison to computing pair-wise attention weights for the objects). Example results illustrating the improved computational costs of using the combined key-value matrix are described in more detail below with reference to FIG. 7.

When the attention neural network receives spatial encodings for the objects as a layer input, the attention neural network can use the spatial encodings as part of generating the updated embeddings for the objects. As described in more detail below with reference to FIG. 5B, by generating the updated embeddings for the objects using the spatial encodings, the attention neural network can generate the updated embeddings using attention weights that are determined based on geometric relationships between the objects.

When the system uses a plurality of shared reference vectors to generate the spatial encodings for the objects, the attention neural network can generate the updated embedding by generating and combining respective embeddings generated using each of the shared reference vectors. As described in more detail below with reference to FIG. 5C, by combining respective embeddings generated using each of the shared reference vectors, the attention neural network can generate the updated object embedding to follow certain symmetry properties (e.g., rotational invariance, equivariance, etc.) of the physical system.

After updating the embedding of the physical system using the one or more processing layers, the system can process the updated embedding of the physical system using an output layer of the prediction neural network to generate a prediction for the physical system (step 508).

FIG. 5B is a flow diagram of an example process for using an attention neural network layer to generate attention weights that depend on spatial encodings for objects in a physical system. For convenience, the process 510 will be described as being performed by a system of one or more computers located in one or more locations. For example, a prediction system, e.g., the prediction system 100 of FIG. 1, appropriately programmed in accordance with this specification, can perform the process 510. The prediction system can, for example, be implemented on GPU or TPU hardware to perform matrix operations efficiently, e.g., in parallel.

The system can receive an input sequence of embeddings for the objects in the physical system (step 512). The input sequence of embeddings can include, for each object of the physical system, an object embedding representing the object.

The system can receive the spatial encodings (e.g., as generated following step 406 of FIG. 4) and shared reference vectors (e.g., as generated following step 404 of FIG. 4) for the objects of the physical system as a layer input (step 514).

The system can process the input sequence of embeddings and the spatial encodings using the attention neural network layer to generate attention weights for the objects (step 516). For example, the attention neural network can generate an attention weight A(qₙ, kₘ) between an n-th object and an m-th object of the physical system following:

$$A ( {q}_{n} , {k}_{m} ) = < {q}_{n} {e}^{i ω \vec{u} \cdot {\vec{r}}_{n}} , {k}_{m} {e}^{i ω \vec{u} \cdot {\vec{r}}_{m}} >$$

Where qₙ is a query feature vector for the n-th object, kₘ is a key feature vector for the m-th object, ω is a parameter for the spatial encodings, u is a shared reference vector for the objects, \vec{r}ₙ is the position of the n-th object in the physical system, and \vec{r}ₘ is the position of the m-th object in the physical system.

The system can process the input embeddings and the attention weights for the objects to generate updated embeddings for the objects (step 518). For example, the attention neural network layer can generate the updated embedding for the n-th object of the physical system as a linear combination specified by:

$${\sum }_{m} < {q}_{n} {e}^{i ω \vec{u} \cdot {\vec{r}}_{n}} , {k}_{m} {e}^{i ω \vec{u} \cdot {\vec{r}}_{m}} > {v}_{m}$$

Where vₘ is a key feature vector for the m-th object.

As described above with reference to FIG. 4, the spatial encodings for the objects can characterize geometric relationships between the objects. By generating the updated embeddings for the objects using the spatial encodings, the attention neural network layer can generate the updated embeddings that can represent or otherwise depend on geometric relationships between the objects.

FIG. 5C is a flow diagram of an example process for generating updated embeddings for objects in a physical system using spatial encodings for the objects for a plurality of shared reference vectors. For convenience, the process 520 will be described as being performed by a system of one or more computers located in one or more locations. For example, a prediction system, e.g., the prediction system 100 of FIG. 1, appropriately programmed in accordance with this specification, can perform the process 520.

The system can receive object embeddings, spatial encodings, and shared reference vectors for the objects in the physical system (step 522). The system can receive the spatial encodings as generated following step 406 of FIG. 4. The system can receive the shared reference vectors as generated following step 404 of FIG. 4.

The system can generate respective updated object embeddings for each of the shared reference vectors (step 524). For example, the system can generate (e.g., following process 510 of FIG. 5B) the respective updated object embedding for a particular shared reference vector based on the received object embeddings and the spatial encodings determined using the particular shared reference vector.

For example, an attention neural network of the system can, for each shared reference vector \vec{u}, generate the updated embedding for the n-th object of the physical system for the shared reference vector \vec{u} following:

$${\sum }_{m} < {q}_{n} {e}^{i ω \vec{u} \cdot {\vec{r}}_{n}} , {k}_{m} {e}^{i ω \vec{u} \cdot {\vec{r}}_{m}} > {v}_{m} {f}^{T} ( \vec{u} )$$

Where f(\vec{u}) is a vector of functions of the shared reference vector u. For example, f can include one or more basis functions for the physical system (e.g., basis functions for unit spheres in the physical system). As a particular example, when the physical system is a three dimensional physical system, f can include one or more spherical harmonic basis functions.

The system can generate output updated object embeddings for the objects of the physical system by combining the updated object embeddings determined for each of the shared reference vectors (step 526). For example, the system can generate the output updated object embeddings for the objects of the physical system as a linear combination of the updated object embeddings determined for each of the shared reference vectors. In some implementations, the weights of a linear combination of the updated object embeddings determined for each of the shared reference vectors can be determined in accordance with a numerical integration or quadrature (e.g., a Lebedev quadrature) across the shared reference vectors. In some implementations, the shared reference vectors can also be determined in accordance with the numerical integration or quadrature.

For example, an attention neural network of the system can generate the output updated embedding for the n-th object of the physical system for the shared reference vector \vec{u} following:

$${\sum }_{\vec{u} ∈ U} {\sum }_{m} < {q}_{n} {e}^{i ω \vec{u} \cdot {\vec{r}}_{n}} , {k}_{m} {e}^{i ω \vec{u} \cdot {\vec{r}}_{m}} > {v}_{m} ⊗ f ( \vec{u} )$$

Where vₘ⊗f(\vec{u}) denotes a tensor product between vₘ and f(\vec{u}).

When the system uses a plurality of shared reference vectors (e.g., as sampled from a distribution of sampled reference vectors, as selected in accordance with a numerical integration with respect to the shared reference vectors, etc.) to generate the spatial encodings for the objects, the attention neural network can generate the updated embedding as an approximation of the integral:

$${\int }_{\vec{u}} < {q}_{n} {e}^{i ω \vec{u} \cdot {\vec{r}}_{n}} , {k}_{m} {e}^{i ω \vec{u} \cdot {\vec{r}}_{m}} > {v}_{m} ⊗ f ( \vec{u} ) d \vec{u}$$

The above integral can produce features for the updated object embedding that respect certain symmetry properties (e.g., rotational invariance, equivariance, etc.) of the physical system. As described in more detail below with reference to FIG. 6, the attention neural network can therefore generate features for the updated embedding that respect the symmetry properties of the physical system.

FIG. 6 illustrates example equivariant vector predictions that can be generated by a prediction system. In particular, FIG. 6 illustrates physically equivalent configurations 602-A and 602-B of objects 604, 606, and 608. The configurations 602-A and 602-B are physically equivalent in the sense that, although the objects 604, 606, and 608 each have different spatial positions within the configurations 602-A and 602-B, the objects 604, 606, and 608 have a same geometric relationship in both configurations 602-A and 602-B. In other words, the configurations 602-A and 602-B represent two “views” of a same physical system of the objects 604, 606, and 608, rather than representing two different physical systems.

Because the configurations 602-A and 602-B represent the same physical system of the objects 604, 606, and 608, predictions and features generated for the physical system generated based on data specifying the configuration 602-A should be related to corresponding predictions and features generated based on data specifying the configuration 602-B. As one example, a predicted energy for the objects 604, 606, and 608 should be unchanged (e.g., invariant) between the configurations 602-A and 602-B. As another example, force or displacement vectors 610-A and 612-A predicted using configuration 602-A should be equivariant, e.g., should relate to physically equivalent corresponding vectors 610-B and 612-B predicted using the configuration 602-B.

As described above with reference to FIG. 3 and FIG. 4, implementations of the systems described in this specification can use spatial encodings for the objects of physical systems in order to generate invariant and equivariant predictions and predicted features for the physical systems. This can enable the described systems to generate more accurate predictions for physical systems and be trained to generate predictions for physical systems more efficiently compared to prediction systems that do not ensure similar invariance and equivariance of predicted features.

FIG. 7 illustrates example experimental results demonstrating improved computational costs of the described methods in comparison with conventional methods. In particular, FIG. 7 illustrates a comparison of the computational time as function of number of objects in a physical system (e.g., the number of graph nodes in a graph representing the physical system) required by conventional methods 702 and by the methods described in this specification 704 for generating predictions for a fully connected graph representing the physical system.

As illustrated, the conventional methods 702 for generating predictions based on the fully connected graph representing the system exhibit a quadratic scaling of computational time with respect to the number of objects, whereas the methods described in this specification 704 exhibit a linear scaling of computational time with respect to the number of objects. Thus, for a same number of objects in a physical system, the described methods 704 can generate predictions for the physical system in less computational time compared to conventional methods 702. Additionally, the conventional methods 702 for generating predictions based on the fully connected graph representing the system exhibit a quadratic scaling of memory usage with respect to the number of objects, which limited the conventional methods 702 to generating predictions for physical systems with less than 2048 objects, whereas the linear scaling of the described methods 704 enable the described methods 704 to generate predictions for physical systems with more than 60,000 objects.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Innovative aspects of the present disclosure are also set out in the following numbered clauses:
1. A method performed by one or more computers, comprising:
   obtaining data characterizing a physical system, the data specifying, for each of a plurality objects in the physical system, a position vector representing a spatial location of the object and one or more physical properties of the object;
   processing the data characterizing the physical system to generate an embedding of the physical system, comprising:
      processing the data characterizing the physical system using an embedding neural network to generate, for each of the plurality of objects in the physical system, a feature embedding for the object representing the one or more physical properties of the object;
      processing the data characterizing the physical system to determine, for each of the plurality of objects in the physical system, a spatial encoding for the object representing the spatial location of the object, wherein:
         the spatial encoding for each object comprises a representation of a complex number characterizing a spatial relationship between the position vector for the object and a shared reference vector; and
      generating the embedding of the physical system by combining, for each of the plurality of objects, the feature embedding for the object with the spatial encoding for the object;
   processing the embedding of the physical system using an attention neural network to generate a network output characterizing a prediction for the physical system; and
   providing the network output characterizing the prediction for the physical system.
2. The method of clause 1, wherein the spatial encoding for each object comprises a representation of a complex number characterizing a dot product between the position vector for the object and a shared reference vector.
3. The method of clause 1 or 2, wherein, for each pair of objects from the plurality of objects, an inner product of the spatial encodings for each of the pair of objects characterizes a distance between the pair of objects.
4. The method of any preceding clause, wherein the spatial encoding for each object comprises a matrix representation of the complex number characterizing the spatial relationship between the position vector for the object and the shared reference vector.
5. The method of any preceding clause, wherein the attention neural network is configured to process the embedding of the physical system by computing a respective attention operation for each of the plurality of objects within the physical system
6. The method of clause 5, wherein, for each of the plurality of objects within the physical system, computing the respective attention operation for the object comprises:
   generating an updated feature embedding for the object as a linear combination of value feature vectors for each of a plurality of other objects of the plurality of objects within the physical system associated with the attention operation for the object, wherein the value feature vector for each other object associated with the attention operation for the object:
      (i) depends on the feature embedding for the other object; and
      (ii) is scaled by an attention weight for the other object that depends on the spatial encoding for the object and the spatial encoding for the other object.
7. The method of clause 6, wherein generating the updated feature embedding for the object as a linear combination of value feature vectors for each of the plurality of other objects within the physical system associated with the attention operation for the object comprises:
   determining a combined key-value matrix for the plurality of objects within the physical system, wherein the combined key-value matrix represents a sum of outer products, comprising respective outer products of key feature vectors with the value feature vectors for each of the plurality of objects within the physical system, wherein each key feature vector depends on a feature embedding for a corresponding object within the physical system; and
   generating the updated feature embedding for the object by computing a product between a query feature vector for the object and the combined key-value matrix for the plurality of objects, wherein the query feature vector for the object depends on the feature embedding the object.
8. The method of any preceding clause, wherein:
   processing the data characterizing the physical system to generate an embedding of the physical system, further comprises:
      generating a plurality of shared reference vectors; and
      for each of the plurality of shared reference vectors:
         determining spatial encodings for each of the plurality of objects for the shared reference vector; and
   processing the embedding of the physical system using the attention neural network to generate the network output characterizing the prediction for the physical system comprises:
      for each of the plurality of objects:
         for each of the plurality of shared reference vectors, generating a respective updated feature embedding for the object and for the shared reference vector that depends on the spatial encodings determined for the shared reference vector; and
         generating an updated feature embedding for the object as a linear combination of the updated feature embeddings for the object for each of the plurality of shared reference vectors; and
      generating the network output characterizing the prediction for the physical system by processing the updated feature embeddings for each of the plurality of objects.
9. The method of clause 8, wherein generating the plurality of shared reference vectors comprises randomly sampling the plurality of shared reference vectors from a distribution of shared reference vectors.
10. The method of clause 8 or 9, wherein generating the updated feature embedding for the object as a linear combination of the updated feature embeddings for the object for each of the plurality of shared reference vectors comprises:
   generating the updated feature embedding for the object as a linear combination of the updated feature embeddings for the object for each of the plurality of shared reference vectors determined in accordance with a numerical integration with respect to the shared reference vectors.
11. The method of clause 10, wherein generating the plurality of shared reference vectors comprises generating the plurality of shared reference vectors in accordance with the numerical integration with respect to the shared reference vectors.
12. The method of clause 10 or 11, wherein the numerical integration comprises a Lebedev quadrature with respect to the shared reference vectors.
13. The method of any one of clauses 10-12, wherein the linear combination of the updated feature embeddings for the object for each of the plurality of shared reference vectors comprises, for each of the plurality of shared reference vectors, the updated feature embeddings for the object and for the shared reference vector determined by a tensor product of the feature embeddings for the object and the value of one or more basis functions determined using the shared reference vector.
14. The method of clause 13, wherein the basis function comprises a spherical harmonic basis function.
15. The method of any preceding clause, wherein the data characterizing the physical system comprises data specifying, for each of the plurality objects in the physical system, a three-dimensional position vector of the object.
16. The method of claim 15, wherein the physical system comprises a chemical system.
17. The method of claim 16, wherein one or more of the plurality of objects comprise atoms of the chemical system.
18. The method of clause 16 or 17, wherein one or more of the plurality of objects comprise groups of atoms of the chemical system.
19. The method of any of clauses 16-18, wherein one or more of the plurality of objects comprise molecules of the chemical system.
20. The method of any preceding clause, wherein processing the embedding of the physical system using the attention neural network to generate the network output characterizing the prediction for the physical system comprises:
   processing the embedding of the physical system using the attention neural network to generate a network output characterizing predicted energies for the plurality of objects in the physical system.
21. The method of clause 20, wherein processing the embedding of the physical system using the attention neural network to generate the network output characterizing the prediction for the physical system comprises:
   processing the embedding of the physical system using the attention neural network to generate a network output characterizing predicted inter-atomic forces for the physical system.
22. The method of clause 21, wherein the attention neural network has been trained using a set of training data comprising a plurality of training examples, wherein each training example comprises:
   data characterizing an example chemical system for the training example; and
   one or more target predictions for the example chemical system for the training example.
23. The method of clause 22, wherein the target predictions for the plurality of training examples include target predictions computed using electronic structure calculations.
24. The method of clause 19 or any of clauses 20-23 when dependent on clause 19, further comprising:
   receiving data characterizing a test molecule; and
   processing the data characterizing the test molecule to generate the data characterizing a physical system, wherein the data characterizing a physical system characterizes a chemical system that includes the test molecule.
25. The method of clause 24, wherein the prediction for the physical system comprises one or more predicted properties of the test molecule.
26. The method of clause 25, further comprising:
   evaluating one or more screening criteria for the test molecule based on the one or more predicted properties of the test molecule; and
   generating, based on the evaluated screening criteria for the test molecule, output data characterizing a decision to physically synthesize the test molecule.
27. The method of clause 26, wherein the output data characterizing the decision to physically synthesize the test molecule data comprises data characterizing a request to physically synthesize the test molecule.
28. The method of any one of clauses 24-27, wherein the test molecule is a protein, optionally a drug.
29. The method of any one of clauses 24-28, wherein the test molecule is a ligand, optionally a ligand of an industrial enzyme, or a drug.
30. The method of any one of clauses 24-29, wherein the predicted properties of the test molecule comprise a predicted binding affinity of the test molecule.
31. The method of clause 30, wherein the predicted binding affinity of the test molecule is for (i) binding of the test molecule to a receptor or enzyme, and optionally the test molecule is an agonist or antagonist of the receptor or enzyme, or (ii) binding of another molecule, such as a candidate molecule for a drug, to the test molecule, and optionally the test molecule is a receptor or enzyme and the other molecule is an agonist or antagonist of the test molecule.
32. The method of any one of clauses 24-31, wherein the predicted properties of the test molecule comprise one or more predicted material properties of the test molecule.
33. The method of any one of clauses 24-32, the predicted properties of the test molecule comprise one or more predicted physio-chemical properties of the test molecule.
34. The method of clause 33, wherein the test molecule is a catalyst of an industrial chemical process and the one or more predicted physio-chemical properties comprise one or more measures or predictors of catalytic activity (e.g., rate coefficients, binding energies, binding lifetimes, diffusion constants, etc.) of the selected test molecule for the industrial chemical process.
35. The method of any one of clauses 24-34, further comprising:
   physically synthesizing the test molecule.
36. The method of any one of clauses 24-35, further comprising testing the biological activity of the test molecule in vitro and/or in vivo.
37. The method of any one of clauses 1-15, further comprising using the network output to determine one or more actions to be performed by an agent interacting with the environment to perform a specified task.
38. The method of clause 37, further comprising instructing the agent to perform the one or more actions.
39. The method of clause 37 or 38, wherein the environment is a real-world environment and the agent comprises (i) a mechanical agent or robot interacting with the real-world environment to perform the specified task, or (ii) an electronic agent controlling items of equipment in the real-world environment to perform the specified task.
40. A system comprising:
   one or more computers; and
   one or more storage devices communicatively coupled to the one or more computers, wherein the one or more storage devices store instructions that, when executed by the one or more computers, cause the one or more computers to perform the method of any of clauses 1-34 or 37-39.
41. One or more non-transitory computer storage media storing instructions that when executed by one or more computers cause the one or more computers to perform the method of any of clauses 1-34 or 37-39.
42. A system comprising:
   one or more computers; and
   one or more storage devices communicatively coupled to the one or more computers, wherein the one or more storage devices store instructions that, when executed by the one or more computers, cause the one or more computers to perform operations comprising:
   obtaining data characterizing a physical system, comprising data specifying, for each a plurality objects in the physical system, a position vector representing a spatial location of the object and one or more physical properties of the object;
   processing the data characterizing the physical system to generate an embedding of the physical system, comprising:
      processing the data characterizing the physical system using an embedding neural network to generate, for each of the plurality of objects in the physical system, a feature embedding for the object representing the one or more physical properties of the object;
      processing the data characterizing the physical system to determine, for each of the plurality of objects in the physical system, a spatial encoding for the object representing the spatial location of the object, wherein:
         the spatial encoding for each object comprises a representation of a complex number characterizing a spatial relationship between the position vector for the object and a shared reference vector; and
      generating the embedding of the physical system by combining, for each of the plurality of objects, the feature embedding for the object with the spatial encoding for the object;
   processing the embedding of the physical system using an attention neural network to generate a network output characterizing a prediction for the physical system; and
   providing the network output characterizing the prediction for the physical system.
43. One or more non-transitory computer storage media storing instructions that when executed by one or more computers cause the one or more computers to perform operations comprising:
   obtaining data characterizing a physical system, comprising data specifying, for each a plurality objects in the physical system, a position vector representing a spatial location of the object and one or more physical properties of the object;
   processing the data characterizing the physical system to generate an embedding of the physical system, comprising:
      processing the data characterizing the physical system using an embedding neural network to generate, for each of the plurality of objects in the physical system, a feature embedding for the object representing the one or more physical properties of the object;
      processing the data characterizing the physical system to determine, for each of the plurality of objects in the physical system, a spatial encoding for the object representing the spatial location of the object, wherein:
         the spatial encoding for each object comprises a representation of a complex number characterizing a spatial relationship between the position vector for the object and a shared reference vector; and
      generating the embedding of the physical system by combining, for each of the plurality of objects, the feature embedding for the object with the spatial encoding for the object;
   processing the embedding of the physical system using an attention neural network to generate a network output characterizing a prediction for the physical system; and
   providing the network output characterizing the prediction for the physical system.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, comprising:
obtaining data characterizing a physical system, the data specifying, for each of a plurality objects in the physical system, a position vector representing a spatial location of the object and one or more physical properties of the object;
processing the data characterizing the physical system to generate an embedding of the physical system, comprising:
processing the data characterizing the physical system using an embedding neural network to generate, for each of the plurality of objects in the physical system, a feature embedding for the object representing the one or more physical properties of the object;
processing the data characterizing the physical system to determine, for each of the plurality of objects in the physical system, a spatial encoding for the object representing the spatial location of the object, wherein:
the spatial encoding for each object comprises a representation of a complex number characterizing a spatial relationship between the position vector for the object and a shared reference vector; and
generating the embedding of the physical system by combining, for each of the plurality of objects, the feature embedding for the object with the spatial encoding for the object;
processing the embedding of the physical system using an attention neural network to generate a network output characterizing a prediction for the physical system; and
providing the network output characterizing the prediction for the physical system.

2. The method of claim 1, wherein the spatial encoding for each object comprises a representation of a complex number characterizing a dot product between the position vector for the object and a shared reference vector.

3. The method of claim 1, wherein, for each pair of objects from the plurality of objects, an inner product of the spatial encodings for each of the pair of objects characterizes a distance between the pair of objects.

4. The method of claim 1, wherein the spatial encoding for each object comprises a matrix representation of the complex number characterizing the spatial relationship between the position vector for the object and the shared reference vector.

5. The method of claim 1, wherein the attention neural network is configured to process the embedding of the physical system by computing a respective attention operation for each of the plurality of objects within the physical system

6. The method of claim 5, wherein, for each of the plurality of objects within the physical system, computing the respective attention operation for the object comprises:
generating an updated feature embedding for the object as a linear combination of value feature vectors for each of a plurality of other objects of the plurality of objects within the physical system associated with the attention operation for the object, wherein the value feature vector for each other object associated with the attention operation for the object:
(i) depends on the feature embedding for the other object; and
(ii) is scaled by an attention weight for the other object that depends on the spatial encoding for the object and the spatial encoding for the other object.

7. The method of claim 6, wherein generating the updated feature embedding for the object as a linear combination of value feature vectors for each of the plurality of other objects within the physical system associated with the attention operation for the object comprises:
determining a combined key-value matrix for the plurality of objects within the physical system, wherein the combined key-value matrix represents a sum of outer products, comprising respective outer products of key feature vectors with the value feature vectors for each object within the physical system, wherein each key feature vector depends on a feature embedding for a corresponding object within the physical system; and
generating the updated feature embedding for the object by computing a product between a query feature vector for the object and the combined key-value matrix for the plurality of objects, wherein the query feature vector for the object depends on the feature embedding the object.

8. The method of claim 1, wherein:
processing the data characterizing the physical system to generate an embedding of the physical system, further comprises:
generating a plurality of shared reference vectors; and
for each of the plurality of shared reference vectors:
determining spatial encodings for each of the plurality of objects for the shared reference vector; and
processing the embedding of the physical system using the attention neural network to generate the network output characterizing the prediction for the physical system comprises:
for each of the plurality of objects:
for each of the plurality of shared reference vectors, generating a respective updated feature embedding for the object and for the shared reference vector that depends on the spatial encodings determined for the shared reference vector; and
generating an updated feature embedding for the object as a linear combination of the updated feature embeddings for the object for each of the plurality of shared reference vectors; and
generating the network output characterizing the prediction for the physical system by processing the updated feature embeddings for each of the plurality of objects.

9. The method of claim 8, wherein generating the plurality of shared reference vectors comprises randomly sampling the plurality of shared reference vectors from a distribution of shared reference vectors.

10. The method of claim 8, wherein generating the updated feature embedding for the object as a linear combination of the updated feature embeddings for the object for each of the plurality of shared reference vectors comprises:
generating the updated feature embedding for the object as a linear combination of the updated feature embeddings for the object for each of the plurality of shared reference vectors determined in accordance with a numerical integration with respect to the shared reference vectors.

11. The method of claim 10, wherein generating the plurality of shared reference vectors comprises generating the plurality of shared reference vectors in accordance with the numerical integration with respect to the shared reference vectors.

12. The method of claim 10, wherein the numerical integration comprises a Lebedev quadrature with respect to the shared reference vectors.

13. The method of claim 10, wherein the linear combination of the updated feature embeddings for the object for each of the plurality of shared reference vectors comprises, for each of the plurality of shared reference vectors, the updated feature embeddings for the object and for the shared reference vector determined by a tensor product of the feature embeddings for the object and the value of one or more basis functions determined using the shared reference vector.

14. The method of claim 13, wherein the basis function comprises a spherical harmonic basis function.

15. The method of claim 1, wherein the data characterizing the physical system comprises data specifying, for each of the plurality objects in the physical system, a three-dimensional position vector of the object.

16. The method of claim 15, wherein the physical system comprises a chemical system.

17. The method of claim 16, wherein processing the embedding of the physical system using the attention neural network to generate the network output characterizing the prediction for the physical system comprises:
processing the embedding of the physical system using the attention neural network to generate a network output characterizing predicted energies for the plurality of objects in the physical system.

18. The method of claim 17, wherein processing the embedding of the physical system using the attention neural network to generate the network output characterizing the prediction for the physical system comprises:
processing the embedding of the physical system using the attention neural network to generate a network output characterizing predicted inter-atomic forces for the physical system.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining data characterizing a physical system, comprising data specifying, for each a plurality objects in the physical system, a position vector representing a spatial location of the object and one or more physical properties of the object;
processing the data characterizing the physical system to generate an embedding of the physical system, comprising:
processing the data characterizing the physical system using an embedding neural network to generate, for each of the plurality of objects in the physical system, a feature embedding for the object representing the one or more physical properties of the object;
processing the data characterizing the physical system to determine, for each of the plurality of objects in the physical system, a spatial encoding for the object representing the spatial location of the object, wherein:
the spatial encoding for each object comprises a representation of a complex number characterizing a spatial relationship between the position vector for the object and a shared reference vector; and
generating the embedding of the physical system by combining, for each of the plurality of objects, the feature embedding for the object with the spatial encoding for the object;
processing the embedding of the physical system using an attention neural network to generate a network output characterizing a prediction for the physical system; and
providing the network output characterizing the prediction for the physical system.

20. One or more non-transitory computer storage media storing instructions that when executed by one or more computers cause the one or more computers to perform operations comprising:
obtaining data characterizing a physical system, comprising data specifying, for each a plurality objects in the physical system, a position vector representing a spatial location of the object and one or more physical properties of the object;
processing the data characterizing the physical system to generate an embedding of the physical system, comprising:
processing the data characterizing the physical system using an embedding neural network to generate, for each of the plurality of objects in the physical system, a feature embedding for the object representing the one or more physical properties of the object;
processing the data characterizing the physical system to determine, for each of the plurality of objects in the physical system, a spatial encoding for the object representing the spatial location of the object, wherein:
the spatial encoding for each object comprises a representation of a complex number characterizing a spatial relationship between the position vector for the object and a shared reference vector; and
generating the embedding of the physical system by combining, for each of the plurality of objects, the feature embedding for the object with the spatial encoding for the object;
processing the embedding of the physical system using an attention neural network to generate a network output characterizing a prediction for the physical system; and
providing the network output characterizing the prediction for the physical system.
